(19) United States
(12) Patent Application Publication
(10) Pub. No.: US 2002/0160306 A1
(43) Pub. Date: Oct. 31, 2002

(54) Optical information recording medium and method

(76) Inventors: Katsunari Hanaoka, Atsugi-shi (JP); Kiyoto Shibata, Isehara-shi (JP); Masaru Shinkai, Yokohama-shi (JP); Yasumoto Aman, Atsugi-shi (JP); Hiroshi Miura, Yokohamo-shi (JP); Mokoto Harigaya, Hiratsuka-shi (JP)

Correspondence Address: Ivan S. Kavrukov, Cooper & Dunham LLP, 1185 Avenue of the Americas, New York, NY, 10036, US

(21) Appl. No.: 10/062,885

(22) Filed: Jan. 31, 2002

(30) Foreign Application Priority Data
Jan. 31, 2001 (JP) 2001-24105
Feb. 5, 2001 (JP) 2001-28496
Sep. 10, 2001 (JP) 2001-273406
Oct. 17, 2001 (JP) 2001-319887

(51) Int. Cl. G11B 7/24

(52) U.S. Cl. 430/270.13; 430/945; 428/64.5; 369/275.2; 369/275.5

(57) ABSTRACT

A phase-change recording medium with Sb₃Te compounds which are formed by initialization-less process steps is provided through the formation of recording media having layered structure including suitably selected materials together with methods for fabricating such recording media, thereby leading to DVD-ROM compatible recording media capable of achieving recording density of 2.6 GB or more on a disc of 120 mm in diameter. The recording medium includes an Sb₃Te recording layer and a crystallization accelerating layer formed contiguously with the recording layer. The crystallization accelerating layer is formed to suitably include impurities as record stabilization agents. At least one additional impurity layer may be formed contiguous to said recording and/or crystallization accelerating layer. During recording steps accompanying phase transformation, the impurities in the crystallization accelerating layer diffuse into the recording layer, to thereby result a higher impurity content in the recording layer than that immediately after the layer formation.

### BACKGROUND

1. Field

This patent specification relates in general to an optical information recording medium, and more particularly to a phase-change recording medium and a method for implementing recording on such medium without initialization process steps while still retaining excellent storage durability.

2. Discussion of Background

Optical recording media have recently come into wide use as viable information data storage and archival devices of large capacity.

Japanese Laid-Open Patent Application No. 2000-43415 discusses a phase-change information recording medium including a recording layer consisting of Sb₃Te compounds, in which a metastable phase of the space group Fm3m of the compounds are utilized.

Publication WO 98/47142 discusses another phase-change information recording medium provided with a recording layer containing Ge, Sb and Te as major components and further provided with a crystallization acceleration layer containing at least Bi elements.

As the above publications illustrate, a phase-change recording medium can serve as a recording medium capable of repeated read/write/erase operations by laser beam irradiation, utilizing phase transition between amorphous and crystalline states.

Several features of such recording media and related materials will be described herein below.

Phase-Change Recording Materials

Two recording materials utilized presently in phase-change information recording media are the above noted Sb₃Te compounds which have the metastable Sb₃Te phase of the space group Fm3m (as exemplified by Application 2000-43415), and GeSbTe compounds which have a composition of, or in vicinity of, the eutectic GeTe—Sb₂Te₃ compound and are subjected to hcp to fcc phase change with increase in temperature.

The present disclosure is related to Sb₃Te compounds having the metastable Sb₃Te phase of the space group Fm3m, and with improvement in materials characteristics of the compounds.

In the following description, Sb and Te are referred to as major components, while elements other than Sb and Te that are included in relatively small amounts thereof, are referred to as other elements.

Therefore, two types of materials for forming recording media are primarily described herein below, one including the above mentioned Sb₃Te compounds having the metastable Sb₃Te phase of the space group Fm3m mentioned above, and the other including the compounds of Ge, Sb and Te, as major components, accompanied by a crystallization accelerating layer containing at least Bi.

Although a certain amount of Ge is added as an impurity to the former Sb₃Te compounds, it is noted that the content of, and the effect by, the Ge element are quite different from those in the latter GeSbTe compounds. For example, the addition of Ge into the former compounds is characterized by decrease in crystallization speed with increasing Ge content and a strong dependency of the storage durability of recording media on the Ge content.

In addition, the Ge content in the former compounds is less than 10 atm %, preferably 6 atm %, and most preferably 5 atm %. In the latter GeSbTe compounds, in contrast, the Ge content generally amounts to approximately 20 atm %, and the recording medium capabilities diminish in the range of Ge content of less than 10 atm %. In the former Sb₃Te compounds recording can be achieved even without any Ge content.

Furthermore, these compounds differ in their overwrite characteristics, as well. Namely, erasure steps for the SbTe compounds are achieved by melting and subsequent recrystallization, while these steps for the GeSbTe compounds are carried out through solid phase erasure without melting.

As a result, the density of recorded marks in the Sb₃Te compounds may be increased in principle to an extent corresponding to a decrease in laser beam diameter which is formed through an optical pickup unit. This is in contrast to the GeSbTe compounds, in which the mark length is practically limited to about 0.35 μm.

Utilizing Sb₃Te compounds makes data recording feasible with density exceeding 4.7 GB on a recording disc of 120 mm in diameter.

Initialization Process in Recording Media Fabrication

Following the layer formation in the course of recording media fabrication, Sb₃Te and GeSbTe compounds included in respective recording layers are formed in an amorphous state. Since the reflectivity of the amorphous layers is as low as less than 5%, the recording including such layers can not be readout (or played back) by conventional media drives.

Current Initialization Process Steps and Difficulties

Because of its low reflectivity indicated above, the recording layer has to be subjected to so called initialization process, in which the layer is crystallized by laser annealing process steps to thereby form a crystalline layer having a sufficiently high reflectivity.

In current initialization process steps, the annealing steps are carried out using a semiconductor laser device with beam size of between 100 and 200 μm in the radial direction of the recording disc, and displacing the laser device along the radial direction while rotating the disc.

In order for the recording layer to be uniformly initialized, the area of the recording disc to be initialized is generally irradiated several times. In practice, the laser device is displaced conventionally with such speed as to irradiate the same disc area two or three times. For example, the annealing process of DVD discs is performed using a laser device with beam size of approximately 100 μm in the radial direction, which is displaced at the radial speed of approximately 36 μm per one disc rotation.

This results in an annealing time of about 100 seconds or more for each disc. When the balance in time requirement between this annealing step and other disc fabrication steps is considered, more than ten annealing units may be needed to meet the speed of single layer deposition unit.

Furthermore, in the above-mentioned method of repeated irradiation, it is necessary to strictly control the intensity profile of the laser beams along the radial direction. In the case of DVD disc, for example, if a deviation of 10% or more is found in the intensity in the radial direction from regression analysis, the annealing uniformity for this disc is considered to be unsatisfactory. Further, the deviation margin for a DVD-RW disc is less than ±5%. This requirement on laser intensity profile therefore becomes tighter with increase in recording density.

Because of the tight process margin encountered in the initialization process using laser devices, especially in the recording density of DVD discs or at higher recording densities, the control through the disc production steps becomes more complicated in terms of the intensity profile of each laser device and the intensity difference among laser devices included in initializing apparatuses used in a media production line. It becomes therefore increasingly difficult to maintain satisfactory quality of the recording discs produced as the recording density increases.

Initialization-less Process

In order to alleviate the above noted difficulties in the initialization process, Publication WO 98/47142 discusses utilizing the effect of accelerating the crystallization of chalcogen compounds by the addition of Bi elements.

Namely, according to the Publication, by first depositing a thin Bi layer and subsequently forming a GeSbTe recording layer on top of the Bi layer, the recording layer can be formed as crystallized after layer formation, and the temperature for forming the layers is between 45° C. and 110° C. The Publication illustrates only GeSbTe compounds for forming a recording layer. No description was found of Sb₃Te compounds.

Even if an initialization-less recording layer is formed as disclosed above, the GeSbTe compounds are considered not suitable for achieving higher density recording in contrast to that capability with the Sb₃Te compounds, as indicated earlier. It is therefore not feasible with the GeSbTe compounds to fabricate higher density recording media through initialization-less steps for forming the recording layer.

Difficulties in Previous Initialization Process

Although the above method utilizing the Bi effect of accelerating the crystallization is effective for low temperature crystallization, Bi elements are also known to accelerate the crystallization of amorphous recording marks in the recording layer during storage following data recording. Accordingly, the storage durability of recorded data is also considered deteriorated in the recording media. The above Publication WO 98/47142 has no description of this effect.

Storage Durability and Substrate Temperature

Ge addition is known to be effective for improving storage durability. Since the amount of added Ge elements is directly related to the crystallization temperature, the Ge addition correlates to raised temperature of the recording layer crystallization.

On the other hand, when a crystallization accelerating layer is incorporated, the crystallization temperature of the recording layer is adversely related to the temperature required to form a crystalline recording layer. That is, higher temperatures are required for forming a recording layer having improved storage durability.

In order to alleviate the deterioration in storage durability caused by the Bi addition, the addition of Ge elements becomes desirable. In the present case, adding 5 atm % of Ge elements is suitable to improve the storage durability of the amorphous recorded marks.

Comparison Between GeSbTe and Sb₃Te Compounds

The Ge content in GeSbTe compounds generally is at least about 10 atm %. The crystallization temperature for GeSbTe compounds is approximately 150° C. for this Ge content, and the temperature is approximately 170° C. for 20 atm % Ge content as conventionally utilized. In contrast, for forming Sb₃Te compounds the crystallization temperature is approximately 166° C. with 5 atm % of Ge included. The crystallization temperature is herein measured by the DSC method with a temperature increment of 10° C./min.

The lowermost temperature for forming a crystalline recording layer with satisfactory storage durability is approximately 150° C. for GeSbTe compounds, and approximately 166° C. for Sb₃Te compounds.

As stated earlier, the crystallization temperature of the recording layer is adversely related to the temperature required to form a crystalline recording layer. Therefore, the substrate temperature for forming a crystalline recording layer with satisfactory storage durability is about 20° C. higher for Sb₃Te compounds than that for a GeSbTe layer.

Difficulties in Initialization-less Process for Sb₃Te

The crystallization temperature for forming crystalline recording layer with satisfactory storage durability is approximately 166° C. for Sb₃Te compounds. The substrate temperature that corresponds the above 166° C. crystallization temperature as measured by an apparatus devised by the present inventors, was approximately 90° C.

When recording layers are formed at this temperature, polycarbonate substrates for supporting the recording layer suffer from plastic deformation and birefringence, which are both undesirable in practical use of information recording media.

The temperature for satisfactory substrate handling without causing such deformation during recording layer formation, has been found to be 67° C. for polycarbonate substrates. When recording layers with the above noted 166° C. crystallization temperature are formed at the 67° C. substrate temperature, the reflectivity for the layers is 70% or less of that normally obtained for recording layers after a melt-recrystallization process.

The ratio of the above stated reflectivity to that normally obtained after melt-recrystallization process steps is hereinafter referred to as ‘relative reflectivity’ For relative reflectivity of about 70% for the recording layer prior to recording, the reflectivity changes depend significantly on the number of recording cycles, which is unfavorable for the practical use of RW media.

Also, recording jitters tend to deteriorate during the period of reflectivity change. This deterioration is caused by the change in light absorbency effected by the changing reflectivity which is dependent on the number of recording cycles performed on the recording disc, as indicated above.

Since recording capability is directly related to the absorbency which changes with the recording cycle number, each portion of the recording layer may have different absorbency even within a region of either crystalline or amorphous material. In addition, this effect is more evident at the boundary between the crystalline and amorphous regions in the layer.

As a result, amorphous record marks may be formed not at the exact location desired, but at a location slightly displaced therefrom. This results in an increase in jitters.

Relatively large reflectivity changes are anticipated particularly for the first recording and the first direct overwrite steps, so the increase in jitters during these steps is of primary concern. For relative reflectivity of about 70% as noted earlier, recording jitters generally exceeds 10% during the first direct overwrite, which is unfavorable for practical use. Relative reflectivity of at least 80% prior to recording is desirable for RW media use.

For recording media of relative reflectivity of at least 80%, the relative reflectivity becomes 90% or more after the first recording and this involves a reflectivity fluctuation of less than 10% in the first direct overwrite step. In this case, the above noted difference in absorbency caused by the reflectivity difference may be considered practically insignificant.

For the reasons described herein above, recording media fabrication without an initialization process has been considered difficult for the Sb₃Te compounds and no previous disclosure on such technique has been found to date.

The crystallization temperature for the GeSbTe compounds disclosed in Publication WO 98/47142 is approximately 150° C. for 10 atm % Ge content. That is, crystalline recording layers may be formed having satisfactory storage durability on conventional polycarbonate substrates within heat resisting temperatures for the plastic substrate.

Since the optimum Ge content for the GeSbTe compounds is 20 atm % or more, the Ge content is considerably smaller under the above noted conditions favorable for the initialization-less process, thereby resulting in relatively poor recording characteristics. In addition, a recording density larger than 2.6 GB (on a disc of 120 mm in diameter) in particular is considered not feasible with this compounds.

On the other hand, the Sb₃Te compounds have not been formed at or below the heat resisting temperature for the polycarbonate substrate as a crystalline recording layer having satisfactory storage durability, and initialization-less recording layer formation process has not been carried out for Sb₃Te compounds.

### SUMMARY

Accordingly, it is an object of the present disclosure to provide an optical information recording medium, having most, if not all, of the advantages and features of similarly employed optical recording media, while eliminating many of the aforementioned disadvantages.

It is another object of the present disclosure to provide a phase-change recording medium with Sb₃Te compounds formed by initialization-less process steps, thereby leading to DVD-ROM compatible recording media capable of achieving recording density of 2.6 GB or more on a disc of 120 mm in diameter.

The following brief description is a synopsis of only selected features and attributes of the present disclosure. A more complete description thereof is found below in the section entitled “Description of Preferred Embodiments”.

The phase-change optical recording medium disclosed herein includes at least a recording layer, which contains Sb and Te elements, and is essentially free of other elements or at least of elements selected from the group consisting of Group I and II elements, and a second layer containing at least the other elements, which diffuse into the recording layer during recording steps under irradiation with energetic beams so that the content of the other elements in the recording layer is increased relative to that immediately after the formation of the recording layer.

The recording layer included in the phase-change recording medium essentially consists of Sb and Te, with a ratio in atom % of α(Sb):β(Te)=1.0:1/2.2 or less, and Ge of 5 atom % or less inclusive of none of Ge.

The above noted second layer serves as a crystallization accelerating layer essentially consisting of record stabilization materials and crystallization accelerating materials.

The record stabilization materials are selected from the group consisting of Group IV, IB, III and V elements, and more preferably from the group consisting of Ge, Cu, In, B and N elements. The crystallization accelerating materials are selected from the group consisting of Group V and VI elements, and more preferably from the group consisting of Sb, Bi and Te elements.

As included in the phase-change optical recording medium, the crystallization accelerating layer includes at least Bi and Ge elements. In addition, the crystallization accelerating layer may essentially consist of Bi and Ge, of an amount in atomic number of γ(Bi)<δ(Ge), when the recording layer includes Sb and Te, with a ratio in atomic percent of α(Sb):β(Te)=1.0:1/2.2 or less, and essentially no Ge.

Alternatively, the crystallization accelerating layer may essentially consist of Bi and Ge, of an amount in atomic number of γ(Bi)>δ(Ge), when the recording layer includes Sb and Te, with a ratio in atomic percent of α(Sb):β(Te)=1.0:1/2.2 or less, and Ge of 5 atomic percent or less.

Furthermore, the recording layer and the crystallization accelerating layer, both included in the phase-change optical recording medium disclosed herein, are characterized by being able to be mixed at least partially with one another under irradiation with energetic beams so that the content of Ge in the portion resulted from the mixing is more than 5 atom %, or alternatively the content of Bi resulting from the mixing is less than 5 atom %.

In another embodiment, the phase-change optical recording medium disclosed herein is fabricated including at least a polycarbonate substrate with a thickness of approximately 0.6 mm provided thereon with a recording layer which essentially consists of Sb and Te, with a ratio in atom % of α(Sb):β(Te)=1.0:1/2.2 or less, and essentially no Ge, and with a crystallization accelerating layer which is formed contiguously to the recording layer essentially consisting of record stabilization materials and crystallization accelerating materials, in which the polycarbonate substrate is adhered to another polycarbonate substrate with a thickness of approximately 0.6 mm, whereby an optical recording medium with a thickness of approximately 1.2 mm be formed. The above noted recording layer may alternatively consist of Sb and Te, with a ratio in atom % of α(Sb):β(Te)=1.0:1/2.2 or less, and Ge of 5 atom % or less.

Alternatively, the phase-change optical recording medium is fabricated including at least a polycarbonate substrate with a thickness of approximately 1.0 mm or more provided thereon with a recording layer and a crystallization accelerating layer.

The recording layer essentially consists of Sb and Te, with a ratio in atom % of α(Sb):β(Te)=1.0:1/2.2 or less, and essentially no Ge. The crystallization accelerating layer, which is formed contiguously to the recording layer, essentially consists of record stabilization materials and crystallization accelerating materials. The recording layer may alternatively consist of Sb and Te, with a ratio in atom % of α(Sb):β(Te)=1.0:1/2.2 or less, and Ge of 5 atom % or less.

Alternatively still, the phase-change optical recording medium is fabricated including at least a polycarbonate substrate with a thickness of approximately 1.0 mm or more provided thereon with at least two of each of recording layer and crystallization accelerating layer.

The recording layer essentially consists of Sb and Te, with a ratio in atom % of α(Sb):β(Te)=1.0:1/2.2 or less, and essentially no Ge. The crystallization accelerating layer, which is formed contiguously to the recording layer, essentially consists of record stabilization materials and crystallization accelerating materials. The recording layer may alternatively consist of Sb and Te, with a ratio in atom % of α(Sb):β(Te)=1.0:1/2.2 or less, and Ge of 5 atom % or less.

Furthermore, the phase-change optical recording medium disclosed herein is characterized by the formation an intermediate in any one the phase-change optical recording media disclosed hereinabove prior to the recording steps, having, immediately after the formation of the recording medium, a reflectivity of 80% or more relative to that of crystallized portions formed through recording steps. In addition, the intermediate is formed, by layer forming process steps performed at most at a plastic deformation temperature of a polycarbonate substrate.

The intermediate may alternatively formed for in any one of the phase-change optical recording medium disclosed herein above prior to the recording steps, by at least a first set of layer forming process steps for forming a first thin layer essentially consisting of record stabilization materials and crystallization accelerating materials, and by a second set of layer forming process steps for forming a second thin layer essentially consisting of Sb and Te, with a ratio in atom % of α(Sb):β(Te)=1.0:1/2.2 or less, and practically none of Ge. In addition, the second thin layer may alternatively consist of Sb and Te, with a ratio in atom % of α(Sb):β(Te)=1.0:1/2.2 or less, and Ge of 5 atom % or less.

In other embodiments, a crystallization acceleration layer is provided contiguously to the recording layer, and at least one impurity layer is provided contiguously to the recording layer and/or the crystallization acceleration layer.

In the present disclosure, also described are several methods for recording information data into respective phase-change optical recording media disclosed herein above. These methods include at least the step of diffusing specified elements into a recording layer in recording medium during recording steps under irradiation with energetic beams so that the content of the elements in the recording layer is increased relative to that immediately after the formation of the recording layer.

In addition, in one of the methods for recording information data, the recording layer included in the recording medium, for example, essentially consists of Sb and Te elements, and is essentially free of other elements or at least of elements selected from the group consisting of Group I and II elements, and a second layer also included in the recording medium consists of specified elements.

The recording layer may essentially consist of Sb and Te, with a ratio in atom % of α(Sb):β(Te)=1.0:1/2.2 or less, and Ge of 5 atom % or less inclusive of none of Ge.

The above noted second layer serves as a crystallization accelerating layer essentially consisting of record stabilization materials and crystallization accelerating materials. The record stabilization materials are selected from the group consisting of Group IV, IB, III and V elements, and more preferably from the group consisting of Ge, Cu, In, B and N elements. The crystallization accelerating materials are selected from the group consisting of Group V and VI elements, and more preferably from the group consisting of Sb, Bi and Te elements.

As included in the phase-change optical recording medium, the crystallization accelerating layer includes at least Bi and Ge elements. In addition, the crystallization accelerating layer may essentially consist of Bi and Ge, of an amount in atomic number of γ(Bi)<δ(Ge), when the recording layer includes Sb and Te, with a ratio in atomic percent of α(Sb):β(Te)=1.0:1/2.2 or less, and practically none of Ge. Alternatively, the crystallization accelerating layer may essentially consist of Bi and Ge, of an amount in atomic number of γ(Bi)>δ(Ge), when the recording layer includes Sb and Te, with a ratio in atomic percent of α(Sb):β(TE)=1.0:1/2.2 or less, and Ge of 5 atomic percent or less.

In addition, a crystallization acceleration layer is formed contiguous to the recording layer, and at least one impurity layer is formed contiguous to one or both of the above layers.

The present disclosure and features and advantages thereof will be more readily apparent from the following detailed description and appended claims when taken with drawings.

### BRIEF DESCRIPTION OF THE DRAWINGS

FIG. 1 is a section illustrating an optical information recording medium according to one embodiment disclosed herein;

FIG. 2 is a section illustrating an optical information recording medium according to another embodiment disclosed herein, in which two substrates are provided;

FIG. 3 is a section illustrating an optical information recording medium according to still another embodiment, in which two recording layers are formed on a substrate; and

FIG. 4 includes a timing chart illustrating signal waveforms for forming recorded marks during recording steps.

FIG. 5 is a section view illustrating the optical information recording medium according to an embodiment disclosed herein, in which an impurity layer is provided directly over a recording layer;

FIG. 6 is a section view illustrating the optical information recording medium according to another embodiment disclosed herein, in which an impurity layer is provided directly under a crystallization acceleration layer.

FIG. 7 is a section view illustrating the optical information recording medium according to still another embodiment, in which first and second impurity layers are provided, directly over a recording layer and under a crystallization acceleration layer, respectively; and

FIG. 8 includes graphical plots illustrating a relationship of modulation factors and recording laser power.

### DESCRIPTION OF PREFERRED EMBODIMENTS

In the detailed description which follows, specific embodiments of information recording media and materials for forming information recording media are described together with methods for fabricating such recording media. It should be understood, however, that the present disclosure is not limited to these embodiments, and that the materials and method for recording information through optical recording media techniques disclosed herein may also be adaptable to any form of information recording. Other embodiments will be apparent to those skilled in the art upon reading the following description.

The recording medium disclosed herein is characterized by phase-change recording materials in the medium as well as a layer structure in which a recording layer in the medium is provided such that the content of the elements other than major components (hereinafter referred to as impurities) in the recording layer is increased after recording and erasure cycles relative to that immediately after the recording layer formation.

By ‘major components’ is meant that the recording layer includes primarily Sb and Te elements so as to (1) constitute the compounds in the Sb₃Te phase and (2) maintain the characteristic stoichiometry as the 3:1 compounds sufficient to ensure amorphous-crystalline phase transitions during information recording and erasing steps.

As detailed herein below, the recording medium is also provided with a crystallization accelerating layer which is formed contiguously with the recording layer. The crystallization accelerating layer is formed to suitably include impurities as record stabilization materials or agents. During recording steps accompanying the phase transformation, the thus included impurities diffuse into the recording layer, to thereby result in the above mentioned increase in impurity content in the recording layer relative to that immediately after the recording layer formation.

As a result, the recording layer is formed in advance with layer impurity content than the predetermined impurity content which is required to achieve proper recording layer characteristics. As stated above, the deficiency in impurity content is then supplemented by impurity diffusion from the crystallization accelerating layer during recording steps.

When Ge is included as record stabilization agent in the crystallization accelerating layer, therefore, the Ge content in the recording layer may be as small as 5 atm % or less. And, when the content of Ge in the recording layer is less than 5 atm %, the crystallization temperature for forming the Sb₃Te recording layer becomes lower than 160° C.

Moreover, for crystallization temperature lower than 160° C. for the Sb₃Te recording layer, a recording layer with relative reflectivity of about 80% can be formed by the layer forming process which is carried out at temperatures lower than the plastic deformation temperature for polycarbonate substrate. The Ge content suitable for forming the crystalline recording layer is preferably 3 atm %. In addition, in the forthcoming description of the present disclosure, Ge content less than 1 atm % is considered as being practically free of Ge impurities. Thus, for the purpose of this patent specification and claims, a recording layer that consists essentially of Sb and Te and contains less than 1 atm % Ge is a recording layer that is essentially free of Ge.

The temperatures for forming the Sb₃Te crystalline recording layer are 147° C. and 110° C. for Ge content in the layer of 3 atm % and 1 atm %, respectively. For the above noted layer forming temperature of 147° C., a crystalline recording layer can be formed even at 67° C. polycarbonate substrate temperature, which can be suitably used without initialization process steps. The relative reflectivity of the thus formed layer reaches approximately 80%.

Furthermore, if the crystallization temperature is approximately 110° C., another completely crystallized recording layer can be formed at a substrate temperature of 67° C. having a relative reflectivity of 83% or larger.

In the present disclosure, the recording layer in an optical recording medium preferably includes Sb₃Te compounds. The recording layer is therefore capable of achieving recorded marks at least as small as 0.1 μm in length by decreasing the laser beam diameter for the recording.

The components effectively utilized for the aforementioned record stabilization materials may be selected from the Group IV, IB or III elements, most preferably Ge and preferably Cu, In and B. In addition, N in the group V is also effectively used.

As the crystallization acceleration materials, further components are suitably selected from the Group V or IV elements such as most effectively Sb, Bi or Te.

The crystallization acceleration layer in the optical recording medium includes at least one of the record stabilization materials and crystallization acceleration materials. The crystallization acceleration layer disclosed herein includes most preferably a binary component of Bi and Ge.

In addition, the crystallization acceleration layer may also include further impurity elements to control layer characteristics such as melting point and/or the crystallization speed during melting and/or mixing steps with the recording layer.

The impurity elements may suitably be selected from the group of elements such as Ag, Ca, Cd, Ce, Co, Cr, Fe, Ga, H, Hg, Ir, K, La, Li, Mg, Mn, Mo, Na, Ni, O, P, Pb, Pd, Po, Pr, Pt, Pu, Rb, Rh, Ru, S, Se, Si, Sn, Sr, Th, Ti, Tl, U, Cl and Br.

It is noted herein that the crystallization acceleration layer need not be formed as a completely continuous layer on a substrate to work properly. That is, in the thickness range of up to approximately 1 nm, the layer is formed in patches or islands that can subsequently interconnect to form a thin layer formed on a substrate with increase in thickness. In the present disclosure, the layer is hereinafter referred to as a crystallization acceleration ‘layer’ including when in the form of the above-mentioned islands or patches.

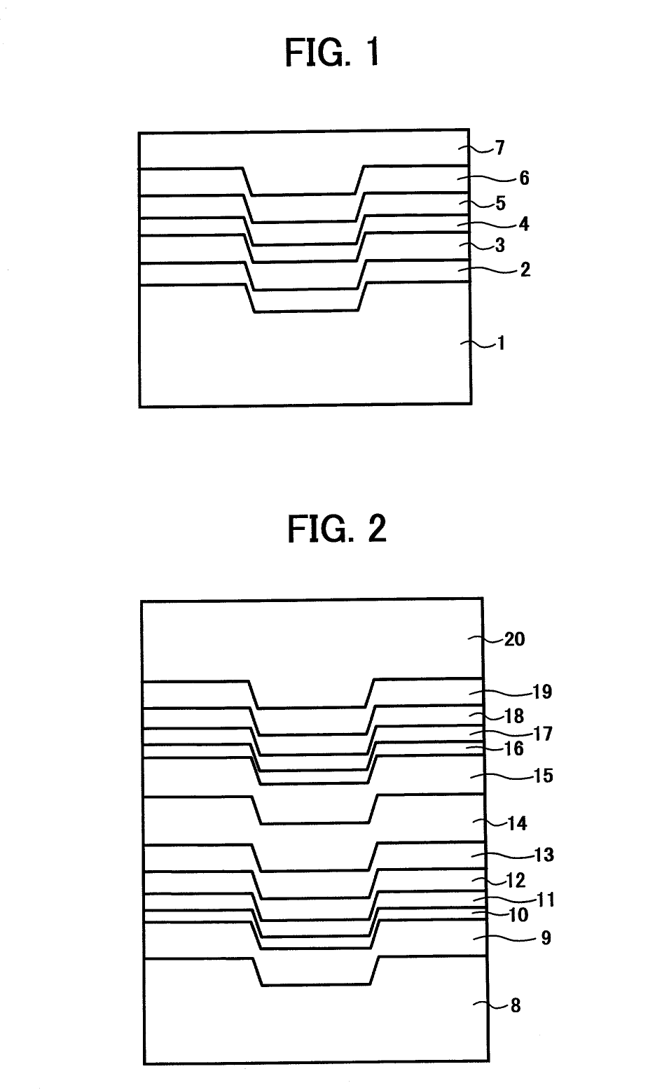

FIG. 1 is a section view illustrating an optical information recording medium according to one embodiment disclosed herein.

Referring to FIG. 1, the recording medium includes at least a substrate 1 and the following layers formed contiguously on the substrate in the order recited, such as a first dielectric layer 2, a crystallization acceleration layer 3, a recording layer 4, a second dielectric layer 5, and a reflective/heat dissipating layer 6. An organic protective layer 7 may further be overlaid, if necessary. It is noted that only the information recording side is shown in FIG. 1 out of the plural constituents for the medium.

Suitable materials for use in the substrate 1 include glass, ceramics and resinous materials. Of these materials, polycarbonate is primarily used for its satisfactory characteristics.

The thickness of the substrate 1 is typically either 1 mm or more, or approximately 0.6 mm. After forming several layers on the substrate of 0.6 mm thickness, as shown in FIG. 1, another substrate of 0.6 mm thickness is adhered thereto, whereby a recording medium is formed with a total thickness of approximately 1.2 mm.

The allowable error of substrate thickness is ±0.3 mm, ±0.2 mm, and ±0.2 mm for thickness of 2.0 mm or more, 1.0 mm and 0.6 mm, respectively.

The substrate is provided with grooves to help guide the laser beams, and the depth of the grooves is approximately from 200 A to 450 A. In addition, the pitch thereof is 0.74 μm for use in a DVD compatible medium. By decreasing the pitch to approximately 0.3 μm and also using a blue emitting laser device, information recording of 20 GB or more becomes feasible on a disc of 120 mm in radius.

Examples of suitable materials for forming the first and second dielectric layers disclosed herein include metal oxides such as SiOₓ, ZnO, SnO₂, Al₂O₃, TiO₂, In₂O₃, MgO, ZrO₂ and Ta₂O₅; nitrides such as Si₃N₄, AlN, TiN, BN and ZrN; sulfides such as ZnS and TaS₄; carbides such as SiC, TaC, B₄C, WC, TiC and ZrC.

These materials may be used individually or in combination. The latter materials in combination are exemplified by ZnS and SiOₓ, and Ta₂O₅ and SiOₓ.

The first dielectric layer is preferably formed having a thickness ranging from 50 nm to 250 nm. With thickness less than 50 nm, the layer cannot serve properly because of the decease in its capabilities such as durability against environmental conditions, thermal resistance and heat storage. In contrast, thickness greater than 250 nm causes difficulties such as peeling-off or cracks at interlayer portions caused by temperature increase during layer formation process steps by the sputtering method, for example, and reduction in recording sensitivity.

The thickness of the second dielectric layer preferably ranges from 15 nm to 50 nm. For thickness thereof less than 10 nm, the layer suffers from decrease in heat storage capability, while it has difficulties, for thickness greater than 100 nm, such as reduction in recording sensitivity, peeling-off and deformation of the layer, caused by temperature increase, and decrease in overwrite characteristics due to decrease in heat dissipation capability.

Examples of suitable materials for forming the reflective/heat dissipating layer 6 disclosed herein include primarily metals or alloys thereof, in which the metals are Al, Au, Cu, Ag, Cr, Sr, Zn, In, Pd, Zr, Fe, Co, Ni, Si, Ge, Sb, Ta, W, Ti and Pb. The reflective/heat dissipating layer 6 is formed preferably having a thickness ranging from 50 nm to 160 nm to dissipate heat efficiently.

If its thickness is unduly large, the layer 6 suffers from decrease in recording sensitivity caused by excessive heat dissipation efficiency, while thickness that is unduly small can cause difficulties such as deterioration in repetitive overwrite characteristics. The reflective/heat dissipating layer 6 is thus required to have preferably relatively high heat conductivity and high melting point, and excellent adhesion strength with the protective layer materials.

FIG. 2 is a section view illustrating an optical information recording medium according to another embodiment disclosed herein, in which two 0.6 mm thick substrates are adhered to one another.

Referring to FIG. 2, each substrate is overlaid with dielectric layers, crystallization acceleration layer, recording layer and reflective/heat dissipating layer. These layers are formed in a similar manner to those illustrated in FIG. 1 using similar materials. In addition, the semitransparent reflective/heat dissipating layer 13 and the first recording layer 11 are each formed to have a transmissivity of 50% or more in the present example.

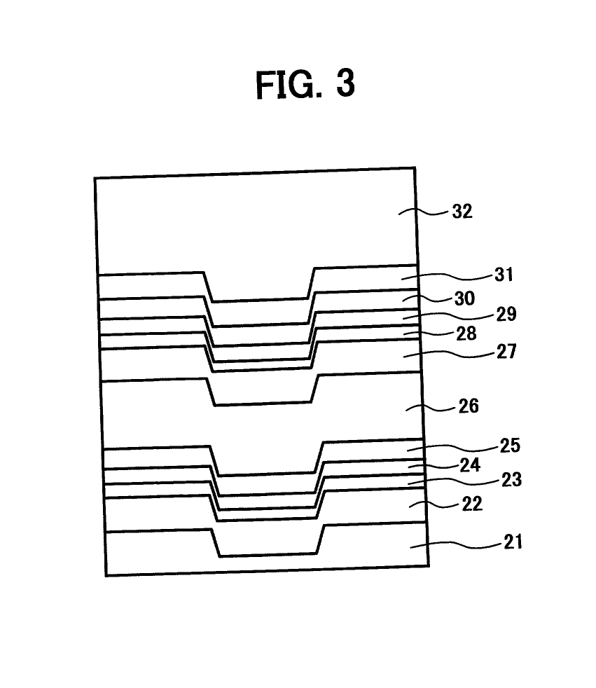

FIG. 3 is a section view illustrating an optical information recording medium according to still another embodiment, in which two recording layers are formed on a 1.0 mm thick substrate.

Referring to FIG. 3, the substrate is overlaid with dielectric layers, crystallization acceleration layer, recording layer and reflective/heat dissipating layer. These layers are formed in a similar manner to those illustrated in FIG. 1 using similar materials.

In addition, to properly control the transmissivity of the first recording layer, the first and fourth dielectric layers 22,30 may alternatively be formed each having a multi-layered structure with different materials.

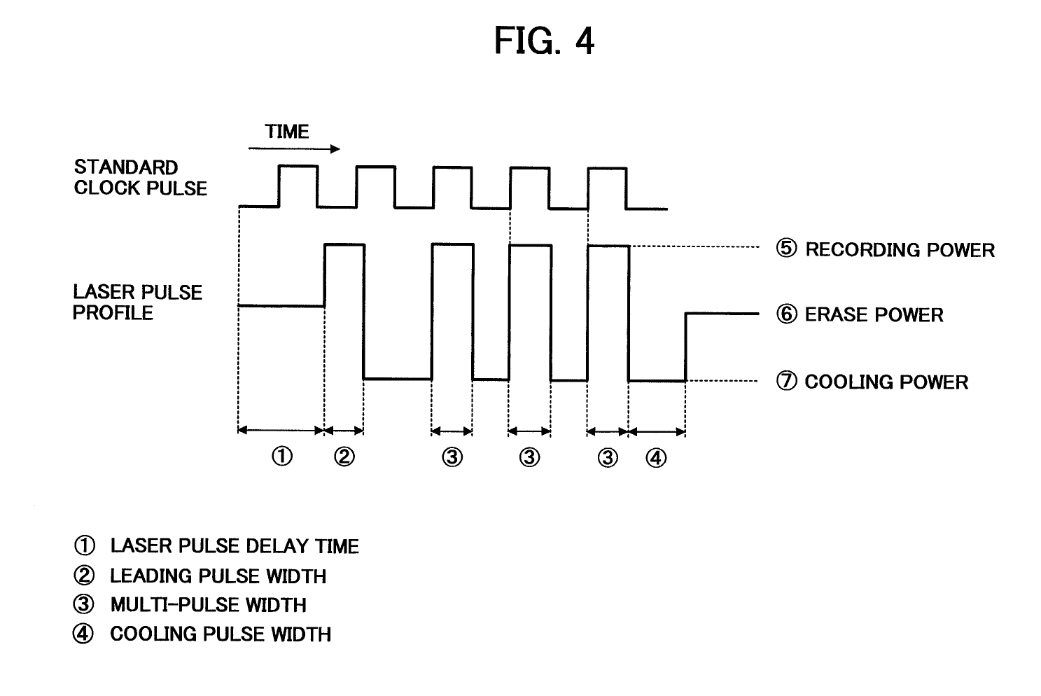

The recording onto the optical recording medium disclosed herein is carried out by irradiating (n−1) laser pulses during the period of n cycles in case of forming an amorphous region which corresponds to the length of n cycles of the standard clock signals. As shown in FIG. 4, for forming an amorphous region corresponding to the length of 5 cycles of the standard clock signals, for example, four laser pulses are irradiated onto the medium.

Referring again to FIG. 4, for data recording with a liner velocity of 8.5 m/s and standard clock signals of 64.7 MHz (DVD recording with 2.4 times of the nominal speed), recording conditions may be taken as (1) 19 ns delay time for starting laser pulse, (2) 7 ns pulse width for the leading pulse, (3) 7 ns pulse width for each consecutive multi-pulses, (4) 14.5 ns cooling pulse width, (5) 15 mW recording power, (6) 8 mW erasure power and (7) 0.1 mW cooling power.

The record and read operation steps are carried out as follows for the optical recording medium disclosed herein which is prepared with the aforementioned materials and construction. For example, these record and read steps are performed using an optical pickup unit having an aperture of NA 0.6 and a semiconductor laser with the emission of 635 or 650 nanometers in wavelength.

As to the recording, the pulse width modulation method may be utilized with the modulation code of EFM or EFM+{8/16 RLL(2,10)}, EFM being Eight to Fourteen Modulation, and RLL being Run Length Limited.

In the present case, the multiple pulses are divided into two portions, one the leading pulse and the other multi-pulses. The latter pulses serve to perform heating and cooling cycle steps onto the recording medium, in which the magnitude of pulse power has the relationship heating (recording) power>erase power>cooling power, and the level of the cooling power is decreased close to that of the reading power. The reading steps are then carried out in general with laser power of approximately 1 mW for linear velocities ranging from 3.5 to 8.5 m/s.

Having generally described the present disclosure, the following examples are provided further to illustrate preferred embodiments. This is intended to be illustrative but not to be limiting to the materials, devices or methods described herein.

### EXAMPLES

A phase-change recording medium was fabricated on a polycarbonate (PC) substrate of 0.6 millimeter thickness, which was provided with pre-grooved guide tracks having a depth ranging approximately from 200 A to 450 A and a pitch of approximately 0.74 μm for CVD media, for example.

The following constituent layers were subsequently formed on the PC substrate in the order recited by sputtering deposition technique using respective sputtering targets: (1) A first dielectric layer of approximately 220 nm thickness formed using a SiO₂.ZnS sputtering target (mol ratio of 79.5:20.5), (2) a crystallization accelerating layer formed using two sputtering targets at the same time (i.e., simultaneous sputtering), one for recording layer stabilization materials and the other for crystallization accelerating materials, (3) a recording layer of approximately 16 nm thickness formed using an Sb₃Te sputtering target, (4) a second dielectric layer of approximately 16 nm thickness formed using SiO₂.ZnS sputtering target (mol ratio of 79.5:20.5), and (5) a reflective/heat dissipating layer of approximately 140 nm thickness formed using an Al sputtering target.

In a similar manner, a plurality of phase-change recording media were further fabricated, in that the crystallization accelerating layers were formed each having different thickness, sputtering targets used therefor had different compositions, and that the sputtering targets for forming the recording layers also had different compositions, as shown in respective columns in Tables 1 through 5.

The numerals in the Tables indicating respective recording layer compositions after read-write (playback-record) operations may include a certain amount of error especially below the decimal point, so the total thereof may deviate from 100% in some instances.

The crystallization accelerating layer in the present example is formed by sputtering two sputtering targets simultaneously, one recording layer stabilization materials target and the other crystallization accelerating materials target. Using these targets and adjusting input power for respective targets during sputtering deposition, crystallization accelerating layers were formed having various Bi/Ge ratios.

Prior to the layer deposition, a substrate was heated using an IR (infrared) lamp with its input power controlled such that the temperature of 100° C. was detected with a thermocouple attached to the substrate. After being stabilized at that temperature, the substrate was transferred into a deposition chamber for the layer formation. The substrate temperature was subsequently found to be 67° C. inside the deposition chamber prior to layer deposition.

Following the layer deposition, a UV (ultraviolet) curing resinous material was disposed, coated over the substrate with the layers previously formed thereon, and then cured under UV beam irradiation. The thus formed substrate was then adhered to another substrate of 0.6 mm thickness, whereby an optical recording medium was formed with a total thickness of approximately 1.2 mm.

Subsequently, 4.7 GB data recording steps were performed at a linear velocity of 5 m/s onto the recording medium of 120 mm in diameter using an optical pickup having an aperture of NA 0.65 and a laser diode with the emission of 660 nanometers in wavelength.

Each recording mark was formed during recording with multi-pulse method in which laser irradiation and cooling steps are repeated. In addition, in order to form an amorphous mark having the length of twice one clock period, the laser irradiation and cooling steps were one less in number than the clock pulses which correspond to one mark length.

Furthermore, the ratio of the laser power for irradiation (recording power) to that for forming crystalline space portions (erase power) during the amorphous mark formation was found to vary its optimum value depending on the thickness and/or materials of the crystallization accelerating layer. This ratio, (recording power)/(erase power), was typically found to be in the range between 0.4 and 0.6.

A variety of characteristic values were subsequently obtained for the thus formed recording media. Among others, ‘jitters’ were calculated as the ratio (in %), which was obtained as the value of standard deviation of distortion in time for reading out the boundary between the recorded mark and space portion, divided by one period of clock time for the readout. ‘Modulation’ was obtained as the value of 14T width divided by 14T reflectivity, T being the time length corresponding to one period of the standard clock signal

### Comparative Examples 1 and 2, Examples 1 through 5

A plurality of phase-change recording media were prepared each including a crystallization accelerating layer and a recording layer as described earlier.

The materials composition of sputtering targets used for the layer deposition and the composition of the layers formed by the deposition are given in respective columns in Table 1. The thickness of the thus formed layers are also included in the Table.

TABLE 1

| | Crystallization | | | | | | | |
|---|---|---|---|---|---|---|---|---|
| | accelerating layer | | Recording layer | | | | | |
| | | Layer | | Layer | | | | |
| | Material | thick- | | thick- | Layer composition | | | |
| | composi- | ness | Material | ness | after mixing (atom %) | | | |
| | tion | (nm) | composition | (nm) | Bi | Ge | Sb | Te |
| Com- | Bi | 0.8 | Sb78Te22 | 16.0 | 4.8 | 0.0 | 74.3 | 21.0 |
| parative | | | | | | | | |
| Exam- | | | | | | | | |
| ple 1 | | | | | | | | |
| Com. | Bi | 0.8 | Ge5Sb77Te1 | 16.0 | 4.8 | 4.8 | 73.3 | 17.1 |
| Ex. 2 | | | 8 | | | | | |
| Ex. 1 | Bi44Ge5 | 1.5 | Sb78Te22 | 16.0 | 3.7 | 4.8 | 71.4 | 20.1 |
| | 6 | | | | | | | |
| Ex. 2 | Bi44Ge5 | 1.6 | Sb78Te22 | 16.0 | 4.0 | 5.1 | 70.9 | 20.0 |
| | 6 | | | | | | | |
| Ex. 3 | Bi44Ge5 | 1.9 | Sb78Te22 | 16.0 | 4.9 | 5.9 | 69.6 | 19.6 |
| | 6 | | | | | | | |
| Ex. 4 | Bi42Ge5 | 1.5 | Sb78Te22 | 16.0 | 3.6 | 4.9 | 71.4 | 20.1 |
| | 8 | | | | | | | |
| Ex. 5 | Bi40Ge6 | 1.5 | Sb78Te22 | 16.0 | 3.4 | 5.1 | 71.4 | 20.1 |
| | 0 | | | | | | | |

Among the characteristic values obtained on the thus formed recording medium (or disc, for short), there shown in Table 2 are (1) the ratio, reflectivity/relative reflectivity, immediately after disc formation (2) jitters during 1st overwrite and (3) the time for 1% jitter increase when 5 stored at 80° C.

TABLE 2

| | (1) Reflectivity/relative | (2) Jitters | (3) Time for 1% |
|---|---|---|---|
| | reflectivity immediately | during 1st | jitter increase when |
| Disc | after disc formation | overwrite | stored at 80° C. |
| Com. Ex. 1 | 20%/85% | 7.0% | Less than 2 hours |
| Com. Ex. 2 | 15%/70% | 12.0% | 100 hours |
| Ex. 1 | 20%/81% | 7.0% | 100 hours |
| Ex. 2 | 20%/82% | 7.2% | 200 hours |
| Ex. 3 | 20%/83% | 7.5% | 250 hours or |
| Ex. 4 | 20%/80% | 7.5% | 100 hours |
| Ex. 5 | 20%/80% | 7.5% | 200 hours |

As shown in Table 1, the crystallization accelerating layer of Example 1 was formed by properly controlling the layer thickness thereof such that the same Ge content as that of Comparative Example 2 was obtained. In a similar manner, the crystallization accelerating layer of Example 3 was formed by controlling the layer thickness thereof such that approximately the same Bi content as that of Comparative Examples 1 and 2 was achieved.

It is also shown from the results in Table 1 that, in the case of using Sb78Te22 material for forming the recording layer in combination with Bi crystallization accelerating layer, the formed medium has a high relative reflectively, while storage durability is considered inadequate.

When the Ge5Sb77Te18 target, to which Ge is added to increase storage durability, is used for forming the recording layer with Bi crystallization accelerating layer, it was found (1) the reflectivity of the recording medium was relatively low immediately after the layer formation, since the recording layer could not be completely crystallized through initialization-less formation steps, (2) a higher substrate temperature was required to achieve a thoroughly crystallized recording layer, and (3) jitters during 1st overwrite exceeded a desirable value, since the recording layer again could not be completely crystallized and the relative reflectivity thereof was 70%.

In the recording media (or discs) of Examples 1 through 3, in contrast, it was found that the reflectivity immediately after the layer formation and storage durability at 80° C. were both satisfactory, and that jitters during 1st overwrite were also satisfactory because of the reflectivity of 80% or more. jitters of less than 9% is practically insignificant for readout steps.

In addition, as to the Ge content after the mixing in the recording layers of Examples 1 and 2, a sudden, two-fold increase in storage durability was achieved in the range of Ge content in excess of 5.0%. Another similar increase was also found for the disc of Example 5 compared with those of Examples 1 and 4.

These sudden increases are believed due to an increased amount of Ge impurity in the recording layer after mixing through recording cycles compared with that immediately after the layer formation.

### Examples 6 through 8

Further phase-change recording media were prepared each including a crystallization accelerating layer and recording layer as described earlier.

The materials composition of sputtering targets used for the layer deposition and the composition of the layers formed by deposition are given in respective columns in Table 3. The thickness of the thus formed layers are also included in the Table.

TABLE 3

| | Crystallization | | | | | | | |
|---|---|---|---|---|---|---|---|---|
| | accelerating layer | | Recording layer | | | | | |
| | | Layer | | Layer | | | | |
| | Material | thick- | | thick- | Layer composition after | | | |
| | composi- | ness | Material | ness | mixing (atom %) | | | |
| | tion | (nm) | composition | (nm) | Bi | Ge | Sb | Te |
| Ex. 6 | Bi60Ge4 | 2.29 | Sb78Te22 | 16.0 | 7.51 | 5.01 | 68.2 | 19.2 |
| | 0 | | | | | | 3 | 5 |
| Ex. 7 | Bi60Ge4 | 1.37 | Ge2Sb76.4Te2 | 16.0 | 4.73 | 5.00 | 70.3 | 19.9 |
| | 0 | | 1.6 | | | | 7 | 0 |
| Ex. 8 | Bi60Ge4 | 0.92 | Ge3Sb75.7Te2 | 16.0 | 3.26 | 5.01 | 71.5 | 20.1 |
| | 0 | | 1.3 | | | | 8 | 4 |

The recording and crystallization accelerating layers were formed by properly controlling the layer thickness thereof such that a Ge content of 5 atm % or more was obtained so as to maintain at least 200 hours of storage durability.

On the thus formed discs, characteristics measurements were taken and the results obtained from the measurements are shown in Table 4 with respect to (1) jitters during 1st recording (2) jitters during recording of 1st overwrite and (3) shelf lives at 80° C.

TABLE 4

| | | (2) Jitters during | |
|---|---|---|---|
| | (1) Jitters during | recording of 1st | |
| Disc | 1st recording | overwrite | (3) Shelf life at 80° C. |
| Ex. 6 | 8% | 9% | 200 hours |
| Ex. 7 | 7% | 8% | 250 hours |
| Ex. 8 | 6.5% | 7.5% | 300 hours or |
| | | | longer |

As shown in Tables 3 and 4, it was found that crystallization accelerating layers can be formed with decreased thickness when a certain amounts of Ge are included in the recording layer in advance, and this also results in decrease in recording jitters. These results facilitate further increase in recording density.

### Examples 9 and 10

Further phase-change recording media were prepared each including a crystallization accelerating layer and recording layer as described earlier.

The materials composition of sputtering targets used for the layer deposition and the composition of the layers formed by the deposition were given in respective columns in Table 5. The thickness of the thus formed layers are also included in the Table.

TABLE 5

| | Crystallization | | | | | | | |
|---|---|---|---|---|---|---|---|---|
| | accelerating layer | | Recording layer | | | | | |
| | | Layer | | Layer | | | | |
| | Material | thick- | Material | thick- | Layer composition after | | | |
| | composi- | ness | compo- | ness | mixing (atom %) | | | |
| | tion | (nm) | sition | (nm) | Bi | Ge | Sb | Te |
| Ex. | Bi44Ge5 | 2.00 | AgSb79Te | 16.0 | 4.89 | 6.22 | 70.2 | 16.0 |
| 9 | 6 | | 18 | | | | 2 | 0 |
| Ex. | Bi44Ge5 | 2.00 | In3Sb79Te | 16.0 | 4.89 | 6.22 | 70.2 | 16.0 |
| 10 | 6 | | 18 | | | | 2 | 0 |

On the thus formed discs, characteristics measurements were taken and the results obtained from the measurements are shown in Table 6 with respect to (1) reflectivity immediately after disc formation, (2) ((maximum-minimum)/average) of reflectivity for 1st through 1000th recordings and (3) modulation during 1000th recording.

TABLE 6

| | (1) Reflectivity | (2) ((Maximum-minimum)/ | |
|---|---|---|---|
| | immediately | average) of reflectivity for | (3) Modulation |
| | after disc | 1st through 1000th | during 1000th |
| Disc | formation | recordings | recording |
| Ex. 1 | 20% | 0.1 | 60% |
| Ex. 9 | 20% | 0.02 | 63% |
| Ex. 10 | 20% | 0.06 | 70% |

As shown in Tables 5 and 6, it was found that, by the addition of Ag elements into the recording layer, fluctuation in reflectivity is decreased for the disc of Example 9 compared with that of Example 1. It was also found that, by the addition of In elements into the recording layer, the modulation value is improved for the disc of Example 10 compared with that of Example 1.

### Examples 11 through 14

Further phase-change recording media were prepared each including a crystallization accelerating layer and recording layer as described earlier.

The recording and crystallization accelerating layers were formed by properly controlling the layer thickness thereof such that a Ge content of 5 atm % or more was obtained so as to maintain at least 200 hours of storage durability.

The materials composition of sputtering targets used for the layer deposition and the composition of the layers formed by the deposition are shown in respective columns in Table 7. The thickness of the thus formed layers are also included in the Table.

TABLE 7

| | Crystallization | | | | | | | |
|---|---|---|---|---|---|---|---|---|
| | accelerating layer | | Recording layer | | | | | |
| | | Layer | | Layer | | | | |
| | Material | thick- | Material | thick- | Layer composition after | | | |
| | composi- | ness | compo- | ness | mixing (atom %) | | | |
| | tion | (nm) | sition | (nm) | Bi | Ge | Sb | Te |
| Ex. | Bi51Ge4 | 1.85 | Sb78Te22 | 16.0 | 5.29 | 5.08 | 69.9 | 19.7 |
| 11 | 9 | | | | | | 2 | 2 |
| Ex. | Bi50Ge5 | 1.81 | Sb78Te22 | 16.0 | 5.08 | 5.08 | 70.0 | 19.7 |
| 12 | 0 | | | | | | 7 | 6 |
| Ex. | Bi48Ge5 | 1.73 | Sb78Te22 | 16.0 | 4.68 | 5.07 | 70.3 | 19.8 |
| 13 | 2 | | | | | | 9 | 5 |
| Ex. | Bi44Ge5 | 1.60 | Sb78Te22 | 16.0 | 4.00 | 5.09 | 70.9 | 20.0 |
| 14 | 6 | | | | | | 1 | 0 |

On the thus formed discs, measurements were taken, for five levels of the Bi/Ge ratio, of (1) modulation after 1000th recording, and the results obtained from the measurements are shown in Table 8.

TABLE 8

| | | (1) Modulation |
|---|---|---|
| | | after 1000th |
| | Bi/Ge | recording |
| Ex. 11 | 51/49 | 60% |
| Ex. 12 | 50/50 | 60% |
| Ex. 13 | 48/52 | 65% |
| Ex. 14 | 44/56 | 66% |

As shown in Tables 7 and 8, it was found that desirable media design is feasible such that satisfactory storage durability is maintained and Bi content in the recording layer is decreased to less than atom % even for the target composition of (Bi content) <(Ge content) for forming the crystallization accelerating layer.

It is also indicated that this facilitates increase in modulation by at least 5%.

### Examples 15 through 19

Further phase-change recording media were prepared each including a crystallization accelerating layer and recording layer as described earlier.

The materials composition of sputtering targets used for the layer deposition and the composition of the layers formed by the deposition are given in respective columns in Table 9. The thickness of the thus formed layers is also included in the Table.

TABLE 9

| | Crystallization | | | | | | | |
|---|---|---|---|---|---|---|---|---|
| | accelerating layer | | Recording layer | | | | | |
| | | Layer | | Layer | | | | |
| | Material | thick- | Material | thick- | Layer composition after | | | |
| | composi- | ness | compo- | ness | mixing (atom %) | | | |
| | tion | (nm) | sition | (nm) | Bi | Ge | Sb | Te |
| Ex. | Bi44Ge5 | 1.60 | Sb77Te23 | 16.0 | 4.00 | 5.09 | 70.0 | 20.9 |
| 15 | 6 | | | | | | 0 | 1 |
| Ex. | Bi44Ge5 | 1.60 | Sb78Te22 | 16.0 | 4.00 | 5.09 | 70.9 | 20.0 |
| 16 | 6 | | | | | | 1 | 0 |
| Ex. | Bi44Ge5 | 1.60 | Sb79Te21 | 16.0 | 4.00 | 5.09 | 71.8 | 19.0 |
| 17 | 6 | | | | | | 2 | 9 |
| Ex. | Bi44Ge5 | 1.60 | Sb80Te20 | 16.0 | 4.00 | 5.09 | 72.7 | 18.1 |
| 18 | 6 | | | | | | 3 | 8 |
| Ex. | Bi44Ge5 | 1.60 | Sb81Te19 | 16.0 | 4.00 | 5.09 | 73.6 | 17.2 |
| 19 | 6 | | | | | | 4 | 7 |

On the thus formed discs, measurements were taken, for five levels of the Sb/Te ratio (atm %), with respect to the effect of Sb/Te ratio on (1) the modulation after 1000th recording. The results obtained from the measurements are shown in Table 10.

TABLE 10

| | Sb/Te | Modulation |
|---|---|---|
| | (ratio in | after 1000^{th} |
| | atom %) | recording |
| Ex. 15 | 3.3 | 70% |
| Ex. 16 | 3.5 | 65% |
| Ex. 17 | 3.8 | 65% |
| Ex. 18 | 4.0 | 55% |
| Ex. 19 | 4.3 | 55% |

As shown in Tables 9 and 10, the modulation value was found to show a drastic change at Sb/Te ratio of 4.0.

### Examples 8, 20 through 22

Further phase-change recording media were prepared each including a crystallization accelerating layer and recording layer as described earlier. The crystallization accelerating layers were formed by properly controlling the relative reflectively of each recording media to be approximately 80%.

The materials composition of sputtering targets used for the layer deposition and the composition of the layers formed by deposition are given in respective columns in Table 11. The thickness of the thus formed layers are also included in the Table.

TABLE 11

| | Crystallization | | | | | | | |
|---|---|---|---|---|---|---|---|---|
| | accelerating layer | | Recording layer | | | | | |
| | | Layer | | Layer | | | | |
| | Material | thick- | | thick- | Layer composition after | | | |
| | composi- | ness | Material | ness | mixing (atom %) | | | |
| | tion | (nm) | composition | (nm) | Bi | Ge | Sb | Te |
| Ex. 8 | Bi60Ge4 | 0.92 | Ge3Sb75.7Te2 | 16.0 | 3.26 | 5.01 | 71.5 | 20.1 |
| | 0 | | 1.3 | | | | 8 | 4 |
| Ex. | Bi55Ge4 | 0.92 | Ge3Sb75.7Te2 | 16.0 | 2.99 | 5.28 | 71.5 | 20.1 |
| 20 | 5 | | 1.3 | | | | 8 | 4 |
| Ex. | Bi50Ge5 | 1.50 | Ge3Sb75.7Te2 | 16.0 | 4.29 | 7.03 | 69.2 | 19.4 |
| 21 | 0 | | 1.3 | | | | 1 | 7 |
| Ex. | Bi44Ge5 | 2.30 | Ge3Sb75.7Te2 | 16.0 | 5.53 | 9.66 | 66.1 | 18.6 |
| 22 | 6 | | 1.3 | | | | 9 | 2 |

On the thus formed discs, measurements were taken of (1) the thickness of crystallization accelerating layer required for 80% reflectivity, (2) jitters during 1st recording, and (3) jitters during recording of 1st overwrite. The results obtained from the measurements are shown in Table 12.

TABLE 12

| | (1) Thickness of | | (3) Jitter |
|---|---|---|---|
| | crystallization accelerating | (2) Jitters | during |
| | layer required for 80% | during 1st | recording of 1st |
| | reflectivity | recording | overwrite |
| Ex. 8 | 0.92 nm | 6.5% | 7.5% |
| Ex. 20 | 0.92 nm | 6.5% | 7.5% |
| Ex. 21 | 1.50 nm | 7.7% | 8.5% |
| Ex. 22 | 2.30 nm | 8.2% | 9% |

As shown in Tables 11 and 12, it was found that satisfactory recording jitters are achieved with the target composition of (Bi content)>(Ge content) for forming crystallization accelerating layers because of the layer thickness thereof of less than 1 nm, which is required for initialization-less process steps.

This result facilitates further increase in recording density.

The process steps set forth in the present description on the constituent layer deposition and various recording media measurements may be implemented using conventional general purpose microprocessors, programmed according to the teachings in the present specification, as will be appreciated by those skilled in the relevant arts. Appropriate software coding can readily be prepared by skilled programmers based on the teachings of the present disclosure, as will also be apparent to those skilled in the relevant arts.

The present invention thus include also a computer-based product which may be hosted on a storage medium, and include instructions which can be used to program a microprocessor to perform a process in accordance with the present disclosure. This storage medium can include, but is not limited to, any type of disc including floppy discs, optical discs, CD-ROMs, magneto-optical discs, ROMs, RAMs, EPROMs, EEPROMs, flash memory, magnetic or optical cards, or any type of media suitable for storing electronic instructions.

It is apparent from the above description including the examples, that a phase-change recording medium with Sb₃Te compounds formed by initialization-less process steps is provided by the formation of recording media with layered structure including suitable materials together with methods of fabricating such recording media, thereby leading to DVD-ROM compatible recording media capable of achieving recording density of 2.6 GB or more on a disc of 120 mm in diameter.

A recording layer included in the information recording medium disclosed herein preferably consists of binary SbTe alloys, essentially free of other elements. By ‘essentially free’ is meant that the content of the other elements is 1.0 atom % at most, which is small enough not to unduly raise the transition temperature of crystallization for the metastable Sb₃Te phase alloy.

According to one embodiment, a crystallization acceleration layer is formed to have a layer thickness less than that required for achieving as-grown crystallization of the recording layer at the same temperature.

It has been found by the present inventors that for the metastable Sb₃Te material to exhibit a practically useful relative reflectivity of 80% or more, a crystallization acceleration layer preferably has a layer thickness greater than a predetermined thickness. In addition, the thickness of the crystallization acceleration layer is negatively correlated to the substrate temperature for forming the recording layer and positively correlated to the transition temperature of crystallization Tc.

For example, a Bi layer of 0.4 nm thickness is required as a crystallization acceleration layer, in order to form an as-grown crystallized Sb76Te24 layer (metastable Sb₃Te alloy with Tc of 110° C.) having a relative reflectivity of 80% or more at 50° C. substrate temperature. In contrast, when the substrate temperature is increased to 70° C., the thickness of the Bi layer can be decreased to 0.3 nm or less.

As another example, in order to form, at 70° C. substrate temperature, an as-grown crystallized Sb75.5Te22.5-Ge2 layer (Tc of 138° C.), the thickness of crystallization acceleration layer of pure Bi has to be 0.8 nm or larger.

On the other hand, heating temperatures for the substrate during practical disc fabrication are approximately 70° C. at most, to alleviate disc deformation such as warping and birefringence.

Several advantages may be cited of the reduced thickness of the crystallization acceleration layer.

First, among the impurities included in the recording layer, the amount of some impurity elements can be reduced to minimal. Such impurities are included in the crystallization acceleration layer and then diffuse into the recording layer to sometimes adversary affect disc properties such as storage durability.

As a result, among amorphous (i.e., recorded state) stabilization elements effective for the metastable Sb₃Te alloys, the content of high melting point materials such as Ge and Cu can be reduced, and the thickness of the impurity layer can also be reduced This facilitates thoroughly mixing three layers (crystallization acceleration, recording, and impurity layers), and reveals useful effects of the amorphous stabilizing elements even after one recording step.

In addition, this reduction in layer thickness will be particularly effective for the trend to shorter wavelengths (blue shift) of the laser beams in record/readout steps for future recording media, in which the layer thickness is decreased and the average impurity content in the crystallization acceleration layer is relatively increased.

Second, the content of stabilization materials can be reduced. Such materials are included in the crystallization acceleration layer to compensate for the above-mentioned adverse effects. As a result, the margin increases for adding other kinds of impurities which are included to improve disc properties.

The total impurity content in the recording layer is approximately 10 atom % at most in order not to impede the formation of the Sb₃Te phase itself, which is caused by high impurity content.

The above-mentioned decrease in total impurities, therefore, facilitates an increase in the margin for supplying other impurities from the impurity, recording and/or crystallization acceleration layers, effective for improving several disc properties. These impurities are Ag for improving reflectivity, and Ga, Mn and Ca for implementing high velocity recording and an appropriate change in recording sensitivity wavelengths, for example.

Third, by reducing the thickness of a crystallization acceleration layer, adversary effects such as decrease in modulation factors can be minimized, which is known to be caused by crystallization acceleration elements, besides other useful effects of the crystallization acceleration layer.

The modulation factors herein are defined by the difference in reflectivity between the recorded mark (amorphous) and in-between space (crystalline) divided by the latter reflectivity of the crystalline portion, and specified to be 60% for 14T signals.

For example, when the content of Bi (crystallization acceleration element) in the recording layer exceeds 5 atom %, the modulation factors decrease below the above specified value at lower laser power range, and the margin with respect to the laser power decreases, thereby resulting in a so called ‘recording medium having a narrow power margin’.

Therefore, the content of Bi in the recording layer is preferably 5 atom % at most, and more preferably 2 atom % or less. This content corresponds to a pure Bi crystallization acceleration layer having a thickness of about 0.4 nm or less, relative to the 15 nm total thickness of the recording and impurity layers.

Examples of suitable materials for forming the impurity layers include binary alloys such as Ag—In, Ag—Sb, Ag—Sn, Ag—Te, Ag—Ge, Al—Ge, Al—Sn, Al—Te, Au—Ge, Cu—In, Cu—Sb, Cu—Sn, Cu—Te, In—Te, In—Sn, In—Mn, In—Sb, Ge—In, Ge—Sb, Ge—Sn, Ge—Te, Ga—In, Ga—Ge, Ga—Sb, Ga—Sn, and Ga—Te; and also ternary alloys of the constituent elements for forming the above-mentioned alloys.

The total amount of impurities in the recording layer after mixing is preferably approximately 10 atom % at most, in order not to impede the formation of the Sb₃Te phase, caused by the high impurity content.

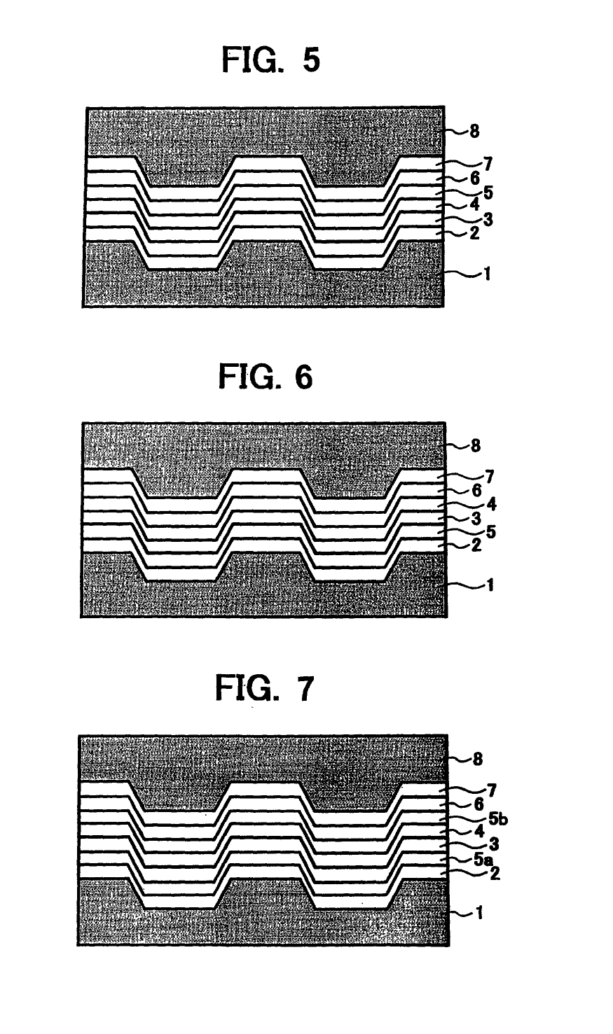

FIG. 5 is a section view illustrating an optical information recording medium according to one embodiment disclosed herein.

Referring to FIG. 5, the recording medium includes at least a substrate 1 and the following layers formed contiguously on the substrate in order as follows: A first dielectric layer 2, a crystallization acceleration layer 3, a recording layer 4, an impurity layer 5, a second dielectric layer 6, and a reflective/heat dissipating layer 7. An organic protective layer 8 may further be overlaid, where relevant.

Alternatively, an impurity layer 5 may be provided directly under the crystallization acceleration layer 3, as shown in FIG. 6. Furthermore, first and second impurity layers 5a, 5b may be provided, directly over the recording layer 4 and under the crystallization acceleration layer 3, respectively, as shown in FIG. 7.

Although the substrate is shown, in FIGS. 5 through 7, only on the side through which information data are recorded or readout, another substrate of 0.6 mm thickness may be adhered onto the other side, to thereby serve as a protective cover. A recording medium is thus formed having a total thickness of 1.2 mm, which is conventionally adopted by rewritable DVD medium such as DVD-RW and others.

In addition, the layer structure of the recording medium is not limited to those illustrated in these drawings. In the case of surface recording type phase change records medium, for example, the recording medium may have a structure, with the layers contiguously formed on the substrate in order as follows, a reflective/heat dissipating layer, a first dielectric layer, an impurity layer, a crystallization acceleration layer, a recording layer, a second dielectric layer, and a cover layer.

That is, the impurity layer(s) may be provided on either one side, or both sides, of the (crystallization acceleration layer)/(recording layer) structure, in which the impurity layer(s) may be formed contiguous to recording layer and/or crystallization acceleration layer.

A variety of characteristic values were obtained for the recording media, each having layer composition as shown in Table 13. These characteristic values were reflectivity of as-grown recording layer (the value of 18% or more is required), DOW (direct overwrite) characteristics, modulation factors, and storage durability.

In regard to the DOW characteristics, recording jitters were examined to determine whether the value of at most 9% was retained from the initial through 1000 times overwrite steps which were carried out at optimum recording power.

In regard to the modulation factors, the examined parameters was whether the value of 60% or larger was satisfied with the recording power ranging from 12.8 mW to 15 mW.

In addition, regarding the storage durability, the examined parameters was whether the increase in jitters remained less than 1% after storage for 100 hours at 80° C. temperature and 85% relative humidity.

During the above measurements, the recording velocity was adjusted to 8.5 m/sec.

In the following Examples 23 through 29, recording media were formed, including a crystallization acceleration layer of Bi alloys, and having an as-grown layer reflectivity of 18% or more.

As a result, readout of the information was feasible without initialization steps for each of the recording media, and the characteristics were found satisfactory on both modulation factor and storage durability.

In addition, the crystal structure of each recording layer was found to belong to the space group Fm3m by X-ray diffraction method.

### Examples 23 through 27

Since each of the recording layers included in the recording media was formed essentially consisting of SbTe binary alloys, a crystallization acceleration layer was able to form having a thickness less than that of Comparative Example 5, 6 or 7, which will be described later on. As a result, the content of the crystallization accelerating materials was relatively small, and no difficulty was encountered in the margin of modulation factors.

In addition, the total amount of impurity elements included in the recording layer remained to be the order of 8 atom %. This made additional materials design feasible, as exemplified by Example 27, such that Ag elements were newly added to improve the reflectivity, and In content was increased to compensate the decrease in modulation factor which was caused by the above mentioned increase in the reflectivity.

### Examples 28 and 29

Record (amorphous) stabilization materials were included in both recording and crystallization acceleration layers. With Bi content of 70%, there found was no difference in either crystallization acceleration effects or the thickness of the crystallization acceleration layer, compared with those with Bi 100% content. Also seen is that with the inclusion of the amorphous stabilization materials distributed over both recording and crystallization acceleration layers, the thickness of the impurity layer could be decreased.

In addition, the impurity layer could be formed essentially consisting of low melting point In alloys. As a result, the increase in jitters during the storage test following the initial recording remained minimal. This is considered to be due to the sufficient mixing, which was achieved even after the initial recording, of the elements among the recording, crystallization acceleration, and impurity layers, whereby satisfactory effects of the amorphous stabilizing elements are revealed.

### Comparative Examples

Without a crystallization acceleration layer, in Comparative Examples 3 and 4, the as-grown recording layers could not be crystallized despite the binary SbTe alloy composition. As a result, readout of information data could not be made from the recording layer without known initialization steps.

In addition, in Comparative Example 4, storage durability was not satisfactory for the recording medium, because of a low average content of Ge, In and Cu elements, which were generally effective for the amorphous stabilization.

In Comparative Example 5, another recording medium was formed such that approximately the same order of Ge and In content as those of Examples 1 through 4 was achieved with only recording and crystallization acceleration layers, i.e., without an impurity layer. The recording layer in the resultant recording medium was found to have a crystallization temperature Tc as high as 175° C.

Since the plastic substrate used in the present disclosure can be heated only up to 70° C. to avoid warping, the recording layer formed at this temperature was found to have a reflectivity value of less than 18%, which is unsatisfactory for achieving readout of information data without known initialization steps. That is, the initialization steps could not be eliminated to achieve satisfactory readout of information data.

The recording layer included in the recording medium of Comparative Example 6 is found to have Tc of 166° C., and its as-grown reflectivity was slightly improved from that of Comparative Example 5. However, for the recording layer which was formed again at the temperature of 70° C. or less, initialization steps could not be eliminated to achieve satisfactory readout of information data.

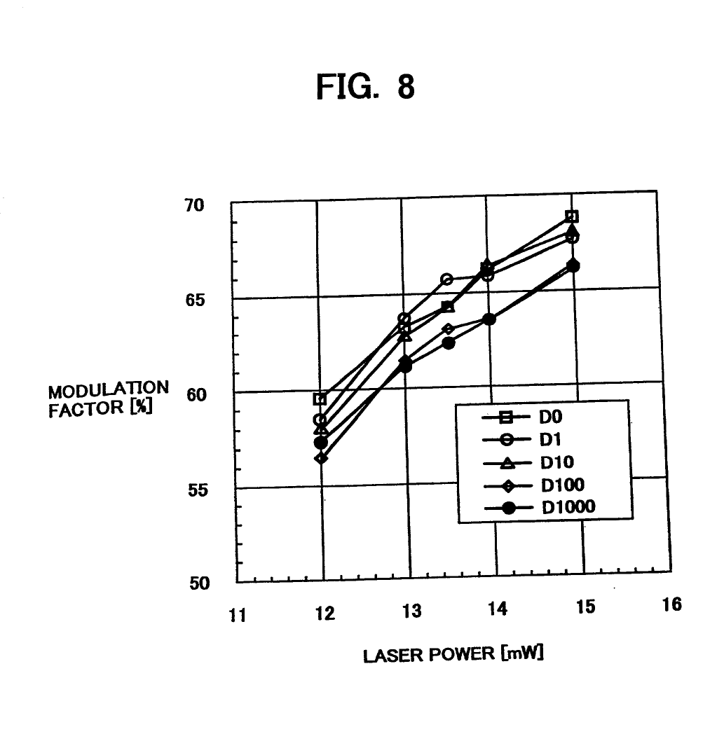

In addition, in contrast to those of Examples 23 through 26, since the recording layer was formed without In content which was effective for achieving satisfactory modulation factors and with Bi content of 5% which was about twice as much, the margin of modulation factor after media initialization was found narrowly above the specified value. Namely, as shown in FIG. 8, the magnitude of modulation factor of 60% or more was narrowly satisfied for the specified recording power ranging from 12.8 mW to 15mW.

There shown in FIG. 8 are results from the measurements, in which graphical plots of the modulation factors versus recording laser power are indicated as D0, D1, D10 and so on, for 0-th direct overwrite (i.e., 1st recording), 1st direct overwrite (i.e., 2nd recording), 10-th direct overwrite and so on, respectively.

In addition, the results on the modulation factors and storage durability were obtained from the measurements as shown in Table 13 on the respective recording medium after the initialization steps, and the marks ‘∘’ in respective columns in the Table indicate that no difficulty was found after the initialization on the modulation factors and storage durability.

In Comparative Example 7, another recording medium was formed with a crystallization acceleration layer having a thickness larger than that of Comparative Example 6. The results turned out unsatisfactory, in that no improvement in as-grown reflectivity was found, and, moreover, modulation factors and storage durability became unsatisfactory because of an increased average Bi content.

It is considered from the results of Comparative Examples 6 and 7 that the effect of the increase in crystallization acceleration layer thickness is already saturated at the order of the layer thickness of Example 26, and that no improvements in as-grown reflectivity can be expected without further increase in substrate temperature. As noted earlier, however, this temperature increase is disadvantageous due to the substrate warping caused at high temperatures.

In addition, in Comparative Examples 5 through 7, the recording layers were found to have a total impurity content of approximately 10 atom %. As a result, a further impurity addition becomes unfeasible since this high impurity content is known to impede the formation of the Sb₃Te phase itself, thereby also making high density recording unfeasible.

In Comparative Examples 8 through 10, each recording medium was found with a total impurity content slightly lower than those of Comparative Examples 5 through 7, having Tc of approximately 140° C. As a result, an as-grown reflectivity of 18% was achieved at 70° C. substrate temperature.

With this layer structure, even though record and readout steps were carried out without initialization, storage durability was found unsatisfactory because the content of In and Ge was less than the order required for satisfactory storage durability.

It is apparent from the above results described in Examples 23 through 29 that by suitably supplying impurity elements from the impurity layer to serve as amorphous stabilization elements, optical information recording media were able to form even at temperature of 70° C. at most, satisfying several media characteristics simultaneously such as as-grown reflectivity, overwrite characteristics, and storage durability, even with decreased Bi content in the recording layer after mixing through recording steps.

TABLE 13-1

| | CA composition | | | | Recording layer (RL) | | | | | Impurity layer (IL) | | | | |
|---|---|---|---|---|---|---|---|---|---|---|---|---|---|---|
| | (at %) | | | | composition (at %) | | | | | composition (at %) | | | | |
| | Bi | In | Cu | Ge | In | Ge | Cu | Sb | Te | Ga | In | Cu | Ag | Te |
| Ex. 23 | 100 | | | | | | | 79.4 | 20.6 | 28 | 28 | | | 44 |
| Ex 24 | 100 | | | | | | | 77.8 | 22.2 | 36 | 35 | | | 29 |
| Ex. 25 | 75 | 25 | | | | | | 78.2 | 21.8 | 36 | 26 | | | 39 |
| Ex. 26 | 80 | | | 20 | | | | 78 6 | 21.4 | 27 | 33 | | | 39 |
| Ex. 27 | 80 | | | 20 | | | | 76.4 | 23.6 | 15 | 45 | | 10 | 30 |
| Ex. 28 | 70 | | | 30 | | | 1 0 | 74.0 | 25.0 | 30 | 70 | | | |
| Ex. 29 | 70 | | 30 | | | 1.0 | | 74.0 | 25 0 | 30 | 70 | | | |
| Com. Ex. 3 | | | | | 3 0 | 3.0 | | 71.0 | 23.0 | | | | | |
| Com. Ex. 4 | | | | | | 3.0 | | 75 0 | 22.0 | | | | | |
| Com Ex 5 | 100 | | | | 3.1 | 3 2 | | 69.8 | 23 9 | | | | | |
| Com. Ex. 6 | 100 | | | | | 5 2 | | 72.7 | 22.1 | | | | | |
| Com. Ex. 7 | 100 | | | | | 5.2 | | 71.0 | 23 8 | | | | | |
| Com Ex. 8 | 100 | | | | | 2 2 | | 73.6 | 24.2 | | | | | |
| Com. Ex. 9 | 100 | | | | 2 0 | 1.2 | | 72 0 | 24.8 | | | | | |
| Com. Ex. 10 | 100 | | | | 2.9 | | | 71.5 | 25.6 | | | | | |

TABLE 13-2

| | Layer thickness | | | Average composition | | | | | | |
|---|---|---|---|---|---|---|---|---|---|---|
| | (nm) | | | after recording (at %) | | | | | | |
| | CA | RL | IL | Ag | In | Ge | Cu | Bi | Sb | Te |
| Ex. 23 | 0.3 | 14.0 | 1.7 | | 3.0 | 3 0 | | 1.8 | 69 4 | 22.8 |
| Ex 24 | 0 3 | 14.0 | 1.3 | | 2.9 | 2.9 | | 2.0 | 69.9 | 22.3 |
| Ex 25 | 0 4 | 14 0 | 1 3 | | 2.8 | 3.0 | | 2.0 | 69.6 | 22 6 |
| Ex. 26 | 0.4 | 14.0 | 1.4 | | 3.0 | 2.9 | | 2.0 | 69.6 | 22.5 |
| Ex. 27 | 0.4 | 14.0 | 1.5 | 1.0 | 4.3 | 2.0 | | 2.0 | 67 2 | 23 7 |
| Ex. 28 | 0.4 | 14.0 | 0.6 | | 3.0 | 2 1 | 0.9 | 2.0 | 68.7 | 23.2 |
| Ex. 29 | 0 4 | 14.0 | 0.6 | | 3.0 | 2.2 | 0 9 | 2 0 | 66.7 | 23.2 |
| Com. Ex. 3 | | 15.0 | | | 3 0 | 3.0 | | | 71.0 | 23.0 |
| Com Ex 4 | | 15.0 | | | | 3 0 | | | 75.0 | 22.0 |
| Com. Ex. 5 | 0.8 | 15.0 | | | 2 9 | 3.0 | | 5.0 | 68.3 | 22.7 |
| Com. Ex 6 | 0 8 | 15 0 | | | | 4.9 | | 5.0 | 69 1 | 21.0 |
| Com. Ex. 7 | 1.2 | 15 0 | | | | 4.8 | | 7 4 | 65.7 | 22 0 |
| Com Ex 8 | 0 8 | 15 0 | | | | 2.1 | | 4.9 | 70.0 | 23 0 |
| Com Ex 9 | 0.8 | 15.0 | | | 1.9 | 1.1 | | 4 9 | 68.4 | 23 6 |
| Com. Ex. 10 | 0.8 | 15.0 | | | 2 8 | | | 4 9 | 68 0 | 24.3 |

TABLE 13-3

| | Evaluation test results | | | |
|---|---|---|---|---|
| | Reflectivity | DOW char- | Modulation | Storage |
| | as-grown | acteristics | factor | durability |
| Ex. 23 | ≧18 | ∘ | ∘ | ∘ |
| Ex. 24 | ≧18 | ∘ | ∘ | ∘ |
| Ex. 25 | ≧18 | ∘ | ∘ | ∘ |
| Ex. 26 | ≧18 | ∘ | ∘ | ∘ |
| Ex. 27 | ≧18 | ∘ | ∘ | ∘ |
| Ex. 28 | ≧18 | ∘ | ∘ | ∘ |
| Ex. 29 | ≧18 | ∘ | ∘ | ∘ |
| Com. Ex. 3 | <5 | x | (∘) | (∘) |
| Com. Ex. 4 | <5 | x | (∘) | x |
| Com. Ex. 5 | <10 | x | (∘) | (∘) |
| Com. Ex. 6 | <13 | x | (∘) | (∘) |
| Com. Ex. 7 | <13 | x | x | x |
| Com. Ex. 8 | ≧18 | ∘ | ∘ | x |
| Com. Ex. 9 | ≧18 | ∘ | ∘ | x |
| Com. Ex 10 | ≧18 | ∘ | ∘ | x |

Numerous additional modifications and variations of the embodiments described above are possible in light of the above teachings. It is therefore to be understood that within the scope of the appended claims, the present invention may be practiced other than as specifically described herein.

This document claims priority and contains subject matter related to Japanese Patent Applications Nos. 2001-24105, 2001-28496, 2001-273406, and 2001-319887 filed with the Japanese Patent Office on Jan. 31, 2001, Feb. 5, 2001, Sep. 10, 2001, and Oct. 17, 2001, respectively, the entire contents of which are hereby incorporated by reference.

What is claimed as new and desired to be secured by Letters Patent of the United States is:

1. A phase-change optical recording medium comprising a recording layer, which as formed contains Sb and Te elements, and is essentially free of other elements or at least of other elements selected from the group consisting of Group I and II elements; and a second layer containing at least one of said other elements; wherein said at least one other element diffuses from said second layer into said recording layer during recording steps under irradiation with energetic beams so that a content of said at least one other element in said recording layer is increased relative to immediately after the formation of said recording layer.

2. The phase-change optical recording medium according to claim 1, wherein said recording layer essentially consists of Sb and Te, with a ratio in atom % of α(Sb):β(Te)=1.0:1/2.2 or less, and is essentially free of Ge.

3. The phase-change optical recording medium according to claim 1, wherein said recording layer essentially consists of Sb and Te, with a ratio in atomic percent of α(Sb):β(Te)=1.0:1/2.2 or less, and has a Ge content of 5 atom % or less.

4. The phase-change optical recording medium according to claim 1, wherein said second layer is a crystallization accelerating layer essentially consisting of record stabilization materials and crystallization accelerating materials.

5. The phase-change optical recording medium according to claim 1, wherein said second layer is formed having a multi-layered structure, including said crystallization accelerating layer and at least one impurity layer which essentially consists of said record stabilization materials and is formed contiguously to said recording layer and/or said crystallization accelerating layer;

6. The phase-change optical recording medium according to claim 4, wherein said record stabilization materials are selected from the group consisting of Group IV, IB, III and V elements.

7. The phase-change optical recording medium according to claim 6, wherein said record stabilization materials are selected from the group consisting of Ge, Cu, In, B and N elements.

8. The phase-change optical recording medium according to claim 4, wherein said crystallization accelerating materials are selected from the group consisting of Group V and VI elements.

9. The phase-change optical recording medium according to claim 8, wherein said crystallization accelerating materials are selected from the group consisting of Sb, Bi and Te elements.

10. The phase-change optical recording medium according to claim 4, wherein said crystallization accelerating layer includes at least Bi and Ge elements.

11. The phase-change optical recording medium according to claim 10, wherein said recording layer is mixed at least partially with said crystallization accelerating layer under irradiation with energetic beams so that a content of Ge in a portion resulting from the mixing is more than 5 atom %.

12. The phase-change optical recording medium according to claim 10, wherein:
said recording layer is mixed at least partially with said crystallization accelerating layer under irradiation with energetic beams so that a content of Bi in a portion resulted from the mixing is less than 5 atom %.

13. The phase-change optical recording medium according to claim 4, wherein said recording layer essentially consists of Sb and Te, with a ratio in atomic percent of α(Sb):β(Te)=1.0:1/2.2 or less, and is essentially free of Ge, and wherein said crystallization accelerating layer essentially consists of Bi and Ge, of an amount in atomic number of γ(Bi)<δ(Ge).

14. The phase-change optical recording medium according to claim 13, wherein said recording layer is mixed at least partially with said crystallization accelerating layer under irradiation with energetic beams so that a content of Ge in a portion resulting from the mixing is more than 5 atom %.

15. The phase-change optical recording medium according to claim 13, wherein said recording layer is mixed at least partially with s aid crystallization accelerating layer under irradiation with energetic beams so that a content of Bi in a portion resulting from the mixing is less than 5 atom %.

16. The phase-change optical recording medium according to claim 10, wherein said recording layer essentially consists of Sb and Te, with a ratio in atomic percent of α(Sb):β(Te)=1.0:1/2.2 or less, and Ge of 5 atomic percent or less, and wherein said crystallization accelerating layer essentially consists of Bi and Ge, of an amount in atomic number of γ(Bi)>δ(Ge).

17. The phase-change optical recording medium according to claim 16, wherein said recording layer is mixed at least partially with said crystallization accelerating layer under irradiation with energetic beams so that a content of Ge in a portion resulting from the mixing is more than 5 atom %.

18. The phase-change optical recording medium according to claim 16, wherein said recording layer is mixed at least partially with said crystallization accelerating layer under irradiation with energetic beams so that a content of Bi in a portion resulting from the mixing is less than 5 atom %.

19. The phase-change optical recording medium according to claim 1, wherein said recording layer essentially consists of Sb and Te, with a ratio in atomic number, Sb/Te equal to, or less than, 4.

20. The phase-change optical recording medium according to claim 1, wherein said recording layer essentially consists of the elements selected from the group consisting of In, Ag and Cu.

21. A phase-change optical recording medium, comprising:
a polycarbonate substrate with a thickness of approximately 0.6 mm provided thereon with a recording layer which essentially consists of Sb and Te, with a ratio in atom % of α(Sb):β(Te)=1.0:1/2.2 or less, and essentially free of Ge, and with a crystallization accelerating layer, which is formed contiguously to said recording layer, essentially consisting of record stabilization materials and crystallization accelerating materials;
wherein said polycarbonate substrate is adhered to a second polycarbonate substrate with a thickness of approximately 0.6 mm to form said optical recording medium with a thickness of approximately 1.2 mm.

22. A phase-change optical recording medium, comprising:
a polycarbonate substrate with a thickness of approximately 1.0 mm or more provided thereon with a recording layer which essentially consists of Sb and Te, with a ratio in atom % of α(Sb):β(Te)=1.0:1/2.2 or less, and essentially free of Ge, and with a crystallization accelerating layer, which is formed contiguously to said recording layer, essentially consisting of record stabilization materials and crystallization accelerating materials.

23. A phase-change optical recording medium, comprising:
a polycarbonate substrate with a thickness of approximately 1.0 mm or more provided thereon with at least two sets of a recording layer which essentially consists of Sb and Te, with a ratio in atom % of α(Sb):β(Te)=1.0:1/2.2 or less, and essentially free of Ge, and a crystallization accelerating layer, which is formed contiguously to said recording layer, essentially consisting of record stabilization materials and crystallization accelerating materials.

24. A phase-change optical recording medium, comprising:
a polycarbonate substrate with a thickness of approximately 0.6 mm provided thereon with a recording layer which essentially consists of Sb and Te, with a ratio in atom % of α(Sb):β(Te)=1.0:1/2.2 or less, and Ge of 5 atom % or less, and with a crystallization accelerating layer, which is formed contiguously to said recording layer, and essentially consists of record stabilization materials and crystallization accelerating materials;
wherein said polycarbonate substrate is adhered to a second polycarbonate substrate of approximately 0.6 mm thickness to form said optical recording medium with a thickness of approximately 1.2 mm.

25. A phase-change optical recording medium, comprising:
a polycarbonate substrate with a thickness of approximately 1.0 mm or more provided thereon with a recording layer which essentially consists of Sb and Te, with a ratio in atom % of α(Sb):β(Te)=1.0:1/2.2 or less, and Ge of 5 atom % or less, and with a crystallization accelerating layer, which is formed contiguously to said recording layer, essentially consisting of record stabilization materials and crystallization accelerating materials.

26. A phase-change optical recording medium, comprising:
a polycarbonate substrate with a thickness of approximately 1.0 mm or more provided thereon with at least two of each of recording layer and crystallization accelerating layer, said recording layer essentially consisting of Sb and Te, with a ratio in atom % of α(Sb):β(Te)=1.0:1/2.2 or less, and Ge of 5 atom % or less, and said crystallization accelerating layer, which is formed contiguously to said recording layer, essentially consisting of record stabilization materials and crystallization accelerating materials.

27. An intermediate included in a phase-change optical recording medium, said intermediate having, immediately after the formation of said recording medium, a reflectivity of 80% or more relative to crystallized portions formed through recording steps in said phase-change optical recording medium, and said intermediate being formed in said phase-change optical recording medium as claimed in any one of claims 1 through 22 prior to said recording steps by layer forming process steps performed at most at a plastic deformation temperature of a polycarbonate substrate.

28. An intermediate included in a phase-change optical recording medium, said intermediate being formed in said phase-change optical recording medium as claimed in any one of claims 1 through 22 prior to said recording steps at least by a first set of layer forming process steps for forming a first thin layer essentially consisting of record stabilization materials and crystallization accelerating materials and by a second set of layer forming process steps for forming a second thin layer essentially consisting of Sb and Te, with a ratio in atom % of α(Sb):β(Te)=1.0:1/2.2 or less, and essentially free of Ge.

29. An intermediate included in a phase-change optical recording medium, said intermediate being formed in said phase-change optical recording medium as claimed in any one of claims 1 through 22 prior to said recording steps at least by a first set of layer forming process steps for forming a first thin layer essentially consisting of record stabilization materials and crystallization accelerating materials and by a second set of layer forming process steps for forming a second thin layer essentially consisting of Sb and Te, with a ratio in atom % of α(Sb):β(Te)=1.0:1/2.2 or less, and Ge of 5 atom % or less.

30. A method for recording information data onto a phase-change optical recording medium, said recording medium comprising a recording layer, which contains Sb and Te elements, and essentially free of other elements or at least essentially free of other elements selected from the group consisting of Group I and II elements; and a second layer containing at least one of said other elements, comprising the step of:
diffusing at least one of said other elements into said recording layer during recording steps under irradiation with energetic beams so that a content of said at least one other elements in said recording layer is increased relative to immediately after the formation of said recording layer.

31. The method according to claim 30, wherein said recording layer essentially consists of Sb and Te, with a ratio in atom % of α(Sb):β(Te)=1.0:1/2.2 or less, and is essentially free of Ge.

32. The method according to claim 30, wherein said recording layer essentially consists of Sb and Te, with a ratio in atom % of α(Sb):β(Te)=1.0:1/2.2 or less, and Ge of 5 atom % or less.

33. The method according to claim 30, wherein said second layer is a crystallization accelerating layer essentially consisting of record stabilization materials and crystallization accelerating materials.

34. The method according to claim 33, wherein said record stabilization materials are selected from the group consisting of Group IV, IB, III and V elements.

35. The method according to claim 34, wherein said record stabilization materials are selected from the group consisting of Ge, Cu, In, B and N elements.

36. The method according to claim 30, wherein said crystallization accelerating materials are selected from the group consisting of Group V and VI elements.

37. The method according to claim 36, wherein said crystallization accelerating materials are selected from the group consisting of Sb, Bi and Te elements.

38. The method according to claim 30, wherein said crystallization accelerating layer includes at least Bi and Ge elements.

39. The method according to claim 38, wherein said recording layer essentially consists of Sb and Te, with a ratio in atomic percent of α(Sb):β(Te)=1.0:1/2.2 or less, and is essentially free of Ge, and wherein said crystallization accelerating layer essentially consists of Bi and Ge, of an amount in atomic number of γ(Bi)<δ(Ge).

40. The method according to claim 38, wherein said recording layer essentially consists of Sb and Te, with a ratio in atomic percent of α(Sb):β(Te)=1.0:1/2.2 or less, and Ge of 5 atomic percent or less, and wherein said crystallization accelerating layer essentially consists of Bi and Ge, of an amount in atomic number of γ(Bi)>δ(Ge).

41. The method according to claim 38, wherein said recording layer is mixed at least partially with said crystallization accelerating layer under irradiation with energetic beams so that a content of Ge in a portion resulting from the mixing is greater than 5 atom %.

42. The method according to claim 38, wherein said recording layer is mixed at least partially with said crystallization accelerating layer under irradiation with energetic beams so that a content of Bi in a portion resulting from the mixing is less than 5 atom %.

43. The method according to claim 30, wherein said recording layer essentially consists of Sb and Te, with a ratio in atomic number, Sb/Te, of equal to, or less than, 4.

44. The method according to claim 30, wherein said recording layer essentially consists of elements selected from the group consisting of In, Ag and Cu.
